(19) United States
(12) Patent Application Publication
(10) Pub. No.: US 2012/0047755 A1
(43) Pub. Date: Mar. 1, 2012

(54) STRAIGHT EDGE CLAMPING DEVICE WITH FRICTIONAL BANDS

(76) Inventor: Eugene EMERSON, Whittier, CA (US)

(21) Appl. No.: 12/862,585

(22) Filed: Aug. 24, 2010

(51) Int. Cl. B43L 7/00

(52) U.S. Cl. 33/430

(57) ABSTRACT

A straight edge clamping device having an elongated hollow base and a clamping device for holding a workpiece on the base is provided. The base having a constant cross-section and comprises: a flat top portion; a flat bottom portion; and frictional bands disposed along the flat bottom portion of the base in a direction of length of the base. The frictional bands increase a friction against the workpiece so as to keep the straight edge clamping device from skidding on the workpiece. The straight edge clamping device may further comprise installing grooves for installing the plurality of frictional bands, and the installing grooves may be disposed on the flat bottom portion in a direction of length of the base. Each of the frictional bands may have a cross-sectional shape substantially same as a corresponding installing groove.

### BACKGROUND OF THE INVENTION

The present invention relates to an extrusion cross-section for a straight edge clamping device. More particularly, the invention relates to an extrusion cross-section for a straight edge clamping device used to secure workpieces and to guide a power tool along the straight edge. Also, the invention relates to an extrusion cross-section for a straight edge clamping device which is strong and robust to external mechanical strain.

Straight edge clamps are used in wood working for having a straight edge secured to a workpiece or workpieces so that a power tool or a guide for a power tool can be moved along the straight edge, for example, to form a cut edge with a circular hand saw or to form a trimmed edge with a hand router. Also, straight edge clamps are used for the purpose of holding accessory tool against a workpiece, for example, to form pocket holes.

A straight edge clamp by prior art includes a straight edge that is made of extruded aluminum and has an open channel, a fixed stop, a sliding stop that is received in the channel and can slide along the straight edge, and a bar or rod clamp. The sliding stop has a body that is inserted in the channel of the straight edge, and a jaw that protrudes from the body and out of the channel to secure a workpiece.

The shape of the straight edge, thickness of its cross-section, and manufacturing tolerance of extruded aluminum affects the stability of the straight edge when working on workpieces, such as making a cut with a hand circular saw, or hand router, or drilling pocket holes with an attached accessory tool.

When the workpiece are clamped between the fixed stop and the sliding stop with the clamping action of the bar clamp, the jaw of the sliding stop is forced against the workpiece, and the body of the sliding stop binds itself within the channel of the straight edge between the top and bottom surfaces of the channel.

The problem in a straight edge clamp by prior art is that aluminum extrusion products used for making straight edges has a minimum dimension variation of 20 mil, and this variation is the potential amount of movement of the straight edge even when the bar clamp of the straight edge clamp is securely engaged. The problem is inherent in the nature of aluminum extrusion.

The variation is affected by many factors such as shape, size and thickness of the straight edge. Such factors also affect the cost of the extrusion and ultimately the cost of the straight edge. Increasing the thickness of the straight edge for example will decrease the manufacturing dimension variation and increase accuracy and usability of the straight edge clamp. However, it increases the ultimate manufacturing cost of the straight edge clamp beyond practicality.

To solve the problems, optimizing of the mechanical structure is very important. The optimized cross-section of the extrusion can attach the variation problem and the manufacturing cost problem effectively.

Accordingly, there has been a demand for a more stable straight edge clamp with material and thus reduced manufacturing cost.

### SUMMARY OF THE INVENTION

The present invention is contrived to overcome the conventional disadvantages. Therefore, an object of the invention is to provide an extrusion cross-section for a straight edge clamp having improved stability of its position while the clamp is engaged while using less material.

Another object of the invention is to provide an extrusion cross-section for a straight edge clamp that enables a power tool to cut a workpiece more accurately when the workpiece is secured by the clamp.

To achieve the objects of the invention for the straight edge clamping device described in the above, a straight edge clamping device having an elongated hollow base and a clamping device for holding a workpiece on the base is provided.

The base having a constant cross-section and comprises: a flat top portion; a flat bottom portion; and a plurality of frictional bands disposed along the flat bottom portion of the base in a direction of length of the base.

The plurality of frictional bands increase a friction against the workpiece so as to keep the straight edge clamping device from skidding on the workpiece.

The straight edge clamping device may further comprise a plurality of installing grooves for installing the plurality of frictional bands, and the plurality of installing grooves may be disposed on the flat bottom portion in a direction of length of the base.

Each of the plurality of frictional bands may have a cross-sectional shape substantially same as a corresponding installing groove.

The cross-sectional shapes may comprise circle, rectangle, pentagon, hexagon.

The flat bottom portion may comprise a first bottom surface and a second bottom surface that are aligned on a plane.

Each of the first and second bottom surfaces may comprise at least one of the plurality of installing grooves.

Each of the first and second bottom surfaces may comprise two of the plurality of installing grooves.

The straight edge clamping device may further comprise two L-cross-sectioned portions and two hollow portions.

The two L-cross-sectioned portions may have a horizontal part and a vertical part, facing each other, and the vertical part of each L-cross-sectional portion may be connected to a bottom surface of the flat top portion.

The two hollow portions may be disposed between the horizontal parts and the flat bottom portion and facing each other, and integrated with the flat bottom portion.

The straight edge clamping device may further comprise two top side grooves and a bottom groove.

Each of the two top side grooves may be provided above one the horizontal part of the L-cross-sectioned portion and partially enclosed by the flat top portion, the vertical part of the L-cross-sectioned portion, and a diagonal extension from the hollow portion.

The bottom groove is disposed below the flat top portion and further partially enclosed by a part of the horizontal part of the L-cross-sectioned portion and the hollow portion.

The straight edge clamping device may further comprise: a first stop fixed at an end of the base; a second stop movably provided along the base; and a clamp for holding the workpieces together.

The second stop may have a body movably received in a channel provided in the bottom groove and a stop for securing the workpieces, and the body of the second stop may have a shape reverse to the shape of the channel so that the body of the second stop and the channel interlock.

Each of the plurality of frictional bands may be attached to the flat bottom portion with glue.

The advantages of the present invention are: (1) the straight edge clamp is kept stable after the workpieces are clamped and during wood working on the workpieces using the frictional bands; and (2) the frictional bands are installed easily under the flat bottom portion of the base.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front elevational view of a straight edge clamping device according to an embodiment of the present invention;

FIG. 2 is a cross-sectional view taken along II-II in FIG. 1; and

FIG. 3 is a cross-sectional view taken along in FIG. 1.

### DETAILED DESCRIPTION OF THE INVENTION

The U.S. Pat. Nos. 6,622,997 and 7,484,306 of the applicant are incorporated by reference into this disclosure as if fully set forth herein.

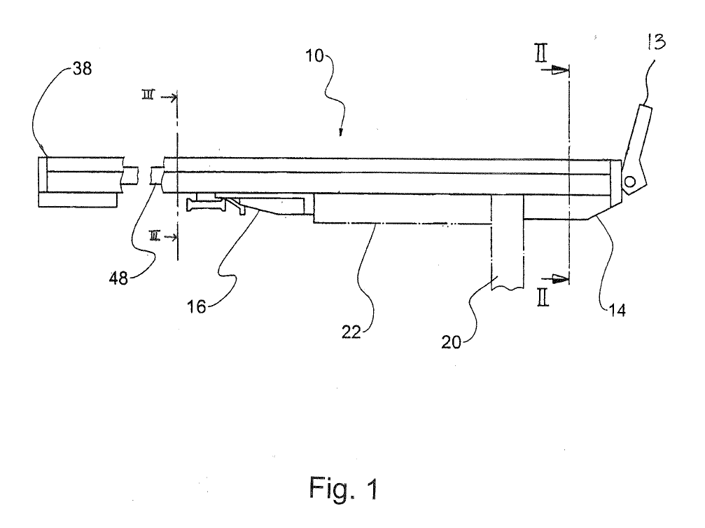

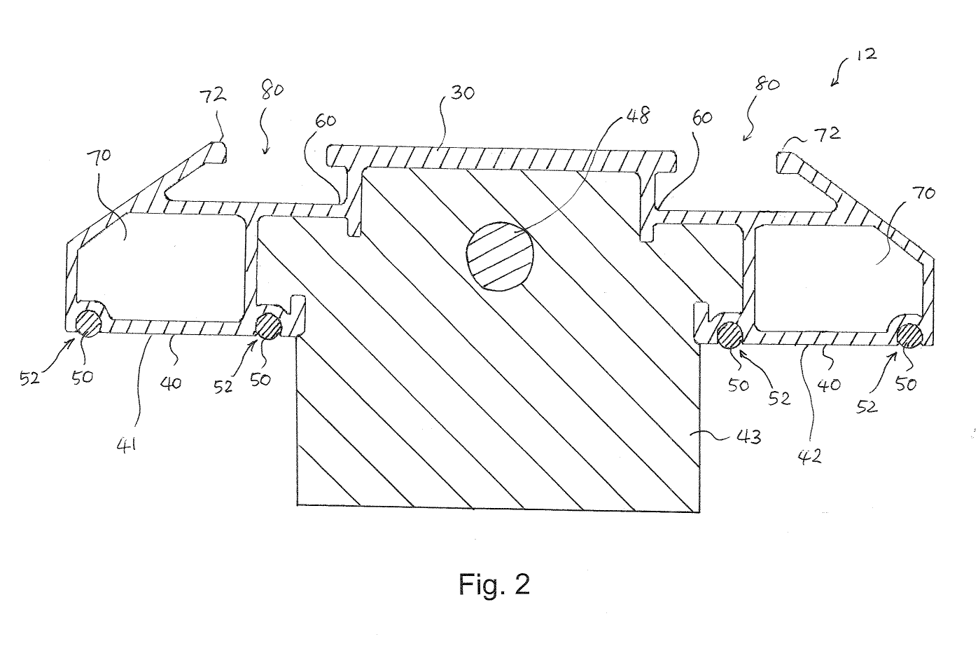

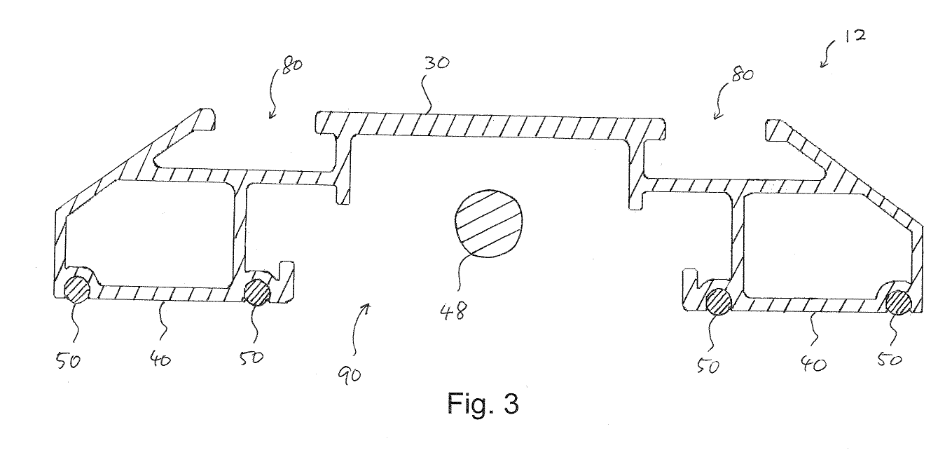

FIG. 1 schematically shows a straight edge clamping device 10 for woodworking. FIGS. 2 and 3 show cross-sections of the straight edge clamping device 10.

To achieve the objects of the invention for the straight edge clamping device 10 described in the above, a straight edge clamping device 10 having an elongated hollow base 12 and a clamping device 14, 16 for holding a workpiece 20, 22 on the base 12 is provided.

The base 12 having a constant cross-section and comprises: a flat top portion 30; a flat bottom portion 40; and a plurality of frictional bands 50 disposed along the flat bottom portion 40 of the base 12 in a direction of length of the base 12.

The plurality of frictional bands 50 increase a friction against the workpiece 20, 22 so as to keep the straight edge clamping device 10 from skidding on the workpiece 20,22.

The straight edge clamping device 10 may further comprise a plurality of installing grooves 52 for installing the plurality of frictional bands 50, and the plurality of installing grooves 52 may be disposed on the flat bottom portion 40 in a direction of length of the base 12.

Each of the plurality of frictional bands 50 may have a cross-sectional shape substantially same as a corresponding installing groove 52.

The cross-sectional shapes may comprise circle, rectangle, pentagon, hexagon.

The cross-section of the frictional bands 50 and the installing groove 52 may be circle as illustrated in FIGS. 2 and 3.

The flat bottom portion 40 may comprise a first bottom surface 41 and a second bottom surface 42 that are aligned on a plane as shown in FIGS. 2 and 3.

Each of the first and second bottom surfaces 41, 42 may comprise at least one of the plurality of installing grooves 52.

Each of the first and second bottom surfaces 41, 42 may comprise two of the plurality of installing grooves 52 as illustrated in FIGS. 2 and 3.

The straight edge clamping device 10 may further comprise two L-cross-sectioned portions 60 and two hollow portions 70.

The two L-cross-sectioned portions 60 may have a horizontal part and a vertical part, facing each other, and the vertical part of each L-cross-sectional portion 60 may be connected to a bottom surface of the flat top portion 30.

The two hollow portions 70 may be disposed between the horizontal parts and the flat bottom portion, facing each other, and integrated with the flat bottom portion 40.

The straight edge clamping device 10 may further comprise two top side grooves 80 and a bottom groove 90.

Each of the two top side grooves 80 may be provided above one the horizontal part of the L-cross-sectioned portion 60 and partially enclosed by the flat top portion 30, the vertical part of the L-cross-sectioned portion 60, and a diagonal extension 72 from the hollow portion 70.

The bottom groove 90 is disposed below the flat top portion 30 and further partially enclosed by a part of the horizontal part of the L-cross-sectioned portion 60 and the hollow portion 70.

The straight edge clamping device 10 may further comprise: a first stop 14 fixed at an end of the base 12; a second stop 16 movably provided along the base 12; and a clamp 13 for holding the workpieces 20, 22 together.

The second stop 16 may have a body movably received in a channel provided in the bottom groove 90 and a stop for securing the workpieces 20, 22, and the body of the second stop 16 may have a shape reverse to the shape of the channel so that the body of the second stop 16 and the channel interlock.

Each of the plurality of frictional bands 50 may be attached to the flat bottom portion 40 with glue.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A straight edge clamping device having an elongated hollow base and a clamping device for holding a workpiece on the base, the base having a constant cross-section and comprising:
a flat top portion;
a flat bottom portion; and
a plurality of frictional bands disposed along the flat bottom portion of the base in a direction of length of the base,
wherein the plurality of frictional bands increase a friction against the workpiece so as to keep the straight edge clamping device from skidding on the workpiece.

2. The straight edge clamping device of claim 1, further comprising a plurality of installing grooves for installing the plurality of frictional bands, wherein the plurality of installing grooves are disposed on the flat bottom portion in a direction of length of the base.

3. The straight edge clamping device of claim 2, wherein each of the plurality of frictional bands has a cross-sectional shape substantially same as a corresponding installing groove.

4. The straight edge clamping device of claim 3, wherein the cross-sectional shapes comprise circle, rectangle, pentagon, hexagon.

5. The straight edge clamping device of claim 2, wherein the flat bottom portion comprises a first bottom surface and a second bottom surface that are aligned on a plane.

6. The straight edge clamping device of claim 5, wherein each of the first and second bottom surfaces comprises at least one of the plurality of installing grooves.

7. The straight edge clamping device of claim 6, wherein each of the first and second bottom surfaces comprises two of the plurality of installing grooves.

8. The straight edge clamping device of claim 7, further comprising:
two L-cross-sectioned portions having a horizontal part and a vertical part, facing each other, wherein the vertical part of each L-cross-sectional portion is connected to a bottom surface of the flat top portion; and
two hollow portions disposed between the horizontal parts and the flat bottom portion and facing each other, and integrated with the flat bottom portion.

9. The straight edge clamping device of claim 8, further comprising:
two top side grooves, each of which being provided above one the horizontal part of the L-cross-sectioned portion and partially enclosed by the flat top portion, the vertical part of the L-cross-sectioned portion, and a diagonal extension from the hollow portion; and
a bottom groove disposed below the flat top portion and further partially enclosed by a part of the horizontal part of the L-cross-sectioned portion and the hollow portion.

10. The straight edge clamping device of claim 9, further comprising:
a first stop fixed at an end of the base;
a second stop movably provided along the base; and
a clamp for holding the workpieces together.

11. The straight edge clamping device of claim 10, wherein the second stop has a body movably received in a channel provided in the bottom groove and a stop for securing the workpieces, wherein the body of the second stop has a shape reverse to the shape of the channel so that the body of the second stop and the channel interlock.

12. The straight edge clamping device of claim 1, wherein each of the plurality of frictional bands is attached to the flat bottom portion with glue.
